(19) United States
(12) Patent Application Publication
(10) Pub. No.: US 2002/0106061 A1
(43) Pub. Date: Aug. 8, 2002

(54) Telephone answering system

(75) Inventor: Gerhard Siemens, Borken (DE)

Correspondence Address: Siemens Corporation, Intellectual Property Department, 186 Wood Avenue South, Iselin, NJ, 08830, US

(73) Assignee: SIEMENS INFORMATION AND COMMUNICATION PRODUCTS, LLC.

(21) Appl. No.: 09/779,013

(22) Filed: Feb. 7, 2001

(51) Int. Cl. H04M 1/64

(52) U.S. Cl. 379/67.1; 379/88.1

(57) ABSTRACT

A method for receiving and storing messages generally comprises receiving an audio message from a caller at an answering device and converting the audio message to a compressed digital message. The compressed digital message is transferred from the answering device to a personal computer for storage of the compressed digital message. When play back of the audio message is requested, the compressed digital message is transferred from the personal computer to the answering device. The method further includes converting the compressed digital message to the original audio message and playing the audio message from the answering device.

### FIELD OF THE INVENTION

The present invention relates generally to telephone answering machines, and more particularly, to a system and method for transferring messages from an answering machine to a computer for storage in a compressed format.

### BACKGROUND OF THE INVENTION

Telephone answering machines allow for the recording and playing of messages received from callers. Analog answering machines, which incorporate cassette tape recording equipment for recording greetings and messages are well known. These machines are often unreliable due to failures in the recording equipment. With advances in technology, digital answering machines have become widely available. A digital answering machine includes a coder for converting analog messages to digital data. The answering machine uses the coder to digitize the greeting and messages, and store the corresponding digital data in memory. By retrieving and converting the stored digital data, the machine can play back the corresponding greeting to callers and messages to users of the machine. In contrast to an analog answering machine, a digital answering machine has no moving tape recording parts, thus providing a more reliable system.

One major drawback to digital answering machines is the limited amount of recording time available to callers. In order to provide an affordable answering machine, most machines include only a limited amount of memory. If the owner of the machine is gone for extended periods of time and does not check his messages, the machine may quickly fill up and no longer be capable of recording messages when new calls are received.

Another method for recording incoming messages is to connect a telephone to a computer, such as a personal computer. Most personal computers can easily provide a large amount of storage space for incoming messages. However, telephone answering applications for personal computers are often unreliable. These applications may freeze or shut down after a period of time or fail to answer the phone when an incoming call is received.

There is, therefore, a need for a telephone answering system that provides the reliability of a digital answering machine with the storage capability of a personal computer.

### SUMMARY OF THE INVENTION

A method for receiving and storing messages with a telephone answering system generally comprises receiving an audio message from a caller at an answering device and converting the audio message to a compressed digital message. The compressed digital message is transferred from the answering device to a personal computer for storage. When play back of the audio message is requested, the compressed digital message is transferred from the personal computer to the answering device. The method further includes converting the compressed digital message to the original audio message and playing the audio message from the answering device.

A telephone answering system of the present invention is operable to transfer messages to a personal computer having memory for storing messages. The system generally comprises an answering device operable to receive an audio message from a caller and convert the audio message to a compressed digital message. The system further includes a controller operable to transfer the compressed data to the personal computer for at least temporary storage thereon and transfer the compressed data back to the answering device for retrieval of the original audio message.

The above is a brief description of some deficiencies in the prior art and advantages of the present invention. Other features, advantages, and embodiments of the invention will be apparent to those skilled in the art from the following description, drawings, and claims.

### BRIEF DESCRIPTION OF THE DRAWINGS

FIG. 1 is a schematic of a telephone answering system of the present invention.

FIG. 2 is a schematic illustrating an example of a computer system that can be utilized to store compressed audio messages.

FIG. 3 is a system block diagram of the computer system of FIG. 2.

FIG. 4 is a block diagram illustrating additional detail of the telephone answering system of FIG. 1.

FIG. 5 is a flowchart illustrating a process of the present invention for transferring compressed data from an answering device to a computer system to archive messages.

Corresponding reference characters indicate corresponding parts throughout the several views of the drawings.

### DETAILED DESCRIPTION OF THE INVENTION

The following description is presented to enable one of ordinary skill in the art to make and use the invention. Descriptions of specific embodiments and applications are provided only as examples and various modifications will be readily apparent to those skilled in the art. The general principles described herein may be applied to other embodiments and applications without departing from the scope of the invention. Thus, the present invention is not to be limited to the embodiments shown, but is to be accorded the widest scope consistent with the principles and features described herein. For purpose of clarity, details relating to technical material that is known in the technical fields related to the invention have not been described in detail.

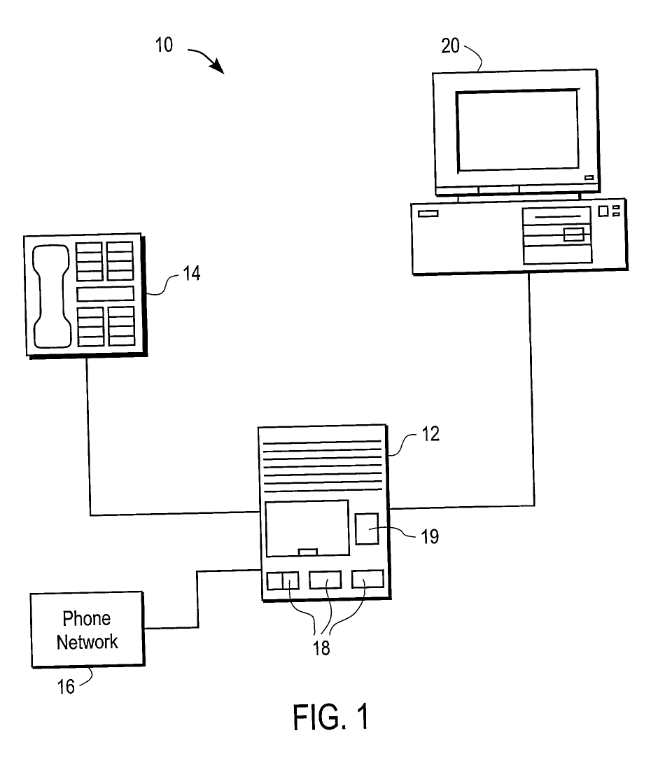

Referring now to the drawings, and first to FIG. 1, a telephone answering system of the present invention is shown and generally indicated at 10. The system 10 is used to transfer compressed audio data from an answering device 12 to a computer 20 to archive messages. The system and method of the present invention provide for fast transfer of messages and storage optimization of the messages. As further described below, the computer 20 may be used to playback messages or the messages may be downloaded back to the answering device 12 and played directly from the answering device. The answering device 12 is connected to a telephone 14, which may a conventional hardwired telephone or a portable telephone handset in communication with a base station, for example. The telephone 14 includes an earpiece and microphone for processing voice information and a keypad for entering telephone numbers, as is well known. The telephone may include additional components such as a keyboard or touch pad for entering data, a display screen for viewing data, or other components available on telephone systems. The telephone is preferably operable to transmit and receive voice information and may also be configured to receive other types of data. The telephone may be an analog telephone or a digital telephone comprising analog-to-digital and digital-to-analog converters. One or more telephones 14 may be coupled to the answering device and one or more answering devices 12 may be coupled to the computer 20.

The answering device 12 includes a plurality of function keys 18 (e.g., rewind, play, record), a display 19 for displaying the number of messages received, two telephone sockets (one for connecting the device to a telephone network 16 and the other for connecting the device to the telephone 14) and a socket for connecting the answering device to the computer 20. The telephone network 16 may be a public switched telephone network (PSTN), for example. The answering device 12 may be activated by incoming ring signals. When activated, an outgoing message having greeting and recording instructions is played to the caller and an incoming message is recorded. Additional functions such as multiple voice mail boxes for recording incoming messages for different individuals of a household may also be included. It is to be understood that the answering device 12 and telephone 14 may be different than shown and described herein without departing from the scope of the invention.

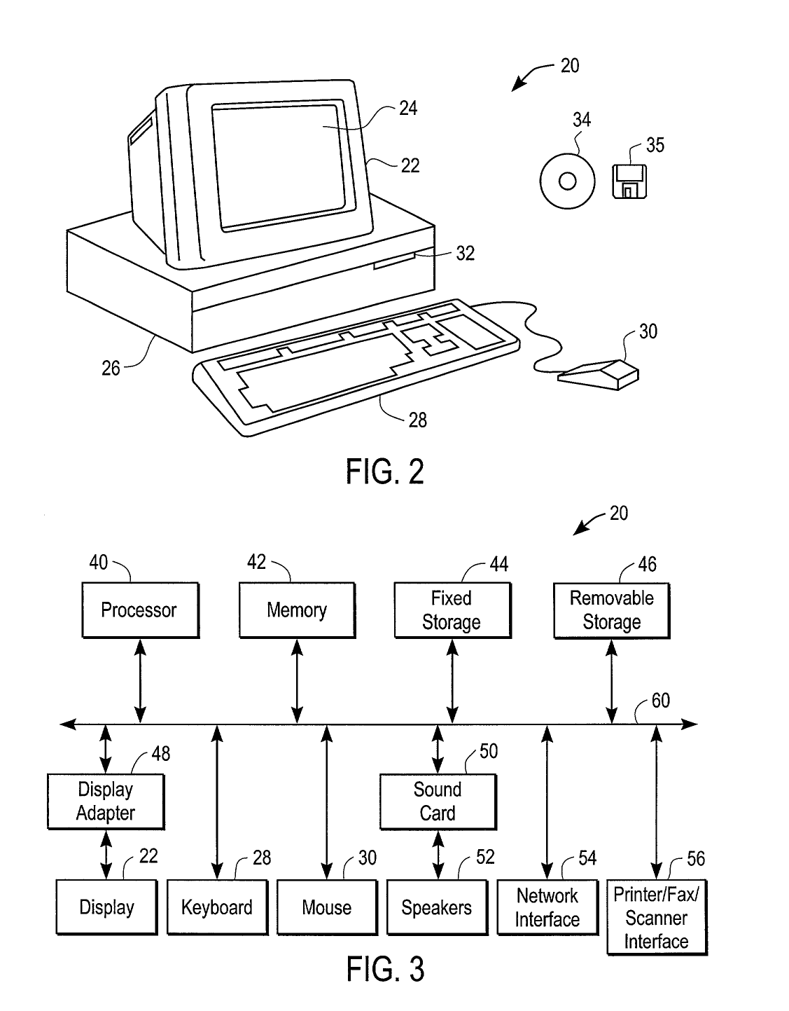

FIG. 2 illustrates an example of a computer system 20 that can be used to store incoming messages in a compressed format, The computer system 20 may be a personal computer system that includes, for example, a display 22, screen 24, cabinet 26, keyboard 28, and mouse 30 which may include one or more buttons for interacting with a GUI (Graphical User Interface). Cabinet 26 houses a CD-ROM drive 32, system memory 42 and a hard drive 44 (see FIG. 3). Although CD-ROM 34 and floppy disk 35 are shown as exemplary computer readable storage media, other computer readable storage media including tape, flash memory, system memory, and hard drive can be utilized. Additionally, a data signal embodied in a carrier wave (e.g., in a network including the Internet) can be the computer readable storage medium.

FIG. 3 shows a system block diagram of the computer system 20. Computer system 20 further includes subsystems such as a central processor 40, system memory 42, fixed storage 44 (e.g., hard drive), removable storage 46 (e.g., CD-ROM drive), display adapter 48, sound card 50, transducers 52 (speakers, microphones, and the like), network interface 54, and printer/fax/scanner interface 56. Other computer systems suitable for use with the invention may include additional or fewer subsystems. For example, computer system 20 may include more than one processor 40 (i.e., a multiprocessor system) or a cache memory.

The system bus architecture of computer system 20 is represented by arrows 60 in FIG. 3. However, these arrows are only illustrative of one possible interconnection scheme serving to link the subsystems. For example, a local bus may be utilized to connect the central processor 40 to the system memory 42 and display adapter 48. Computer system 20 shown in FIGS. 2 and 3 is but an example of a personal computer system suitable for use with the invention. Other computer architectures having different configurations of subsystems may also be utilized.

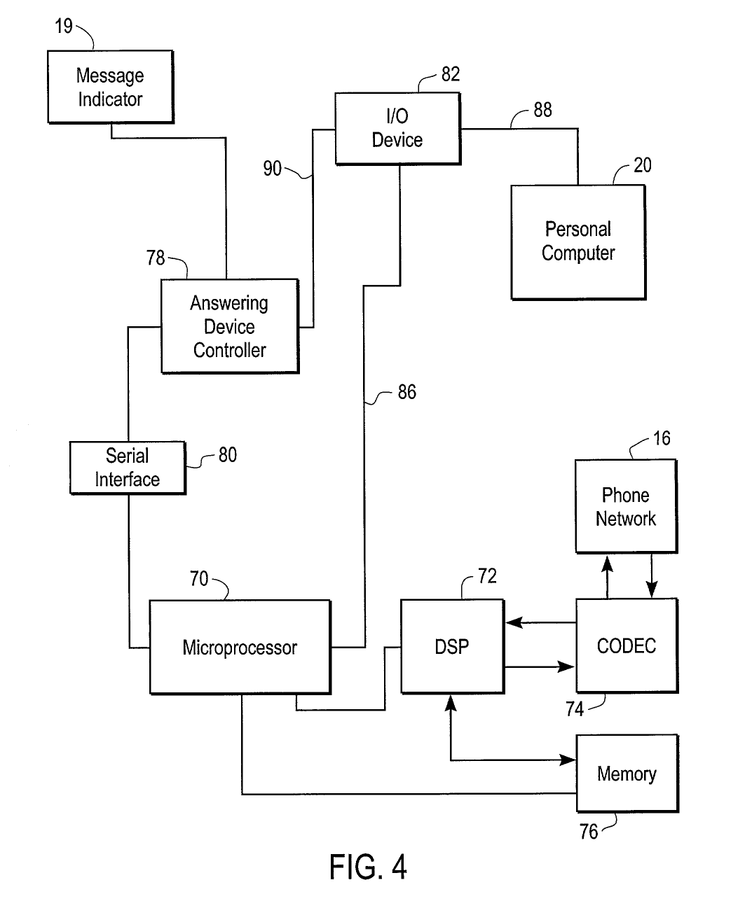

FIG. 4 illustrates additional detail of the answering system 10 of the present invention. The answering device 12 generally includes a microprocessor 70 for controlling operation of the answering device, a digital signal processor (DSP) 72, and a codec (coder/decoder) 74 for encoding analog voice signals transmitted from the telephone network 16 and decoding the digital voice signals from the DSP. The codec 74 includes an analog-to-digital (A/D) converter for converting the audio signal of the incoming message from analog to digital and a digital-to-analog (D/A) converter for converting the digital signal into an analog signal. The DSP 72 compresses and expands data as required. The data is preferably compressed when the digital audio signal of the incoming message is recorded and expanded when it is to be reproduced. The answering device 12 further includes memory 76 used to record the digital signal of the incoming and outgoing messages. Memory 76 may have a capacity of 4 Mbits, for example, and may be capable of recording the outgoing message and incoming messages for about ten minutes.

The microprocessor 70 is coupled to an answering device controller 78 through a serial interface 80 and also coupled to the computer 20 through an input/output device (chip) 82. Line 86 between the microprocessor and input/output device 82 may be a control or data bus and line 88 between the input/output device 82 and computer 20 may be a universal serial bus (USB), for example. The answering device controller 78 is also connected to the input/output device 82 through an acoustic bus 90. The message indicator 19 is connected to the controller 78 which tracks how many incoming messages have been received and recorded. The message indicator 19 may indicate the number of recorded messages by displaying a number or the indicator may flash a number of times corresponding to the number of messages stored. The indicator 19 preferably identifies the number of messages stored on the answering device 12 and computer 20.

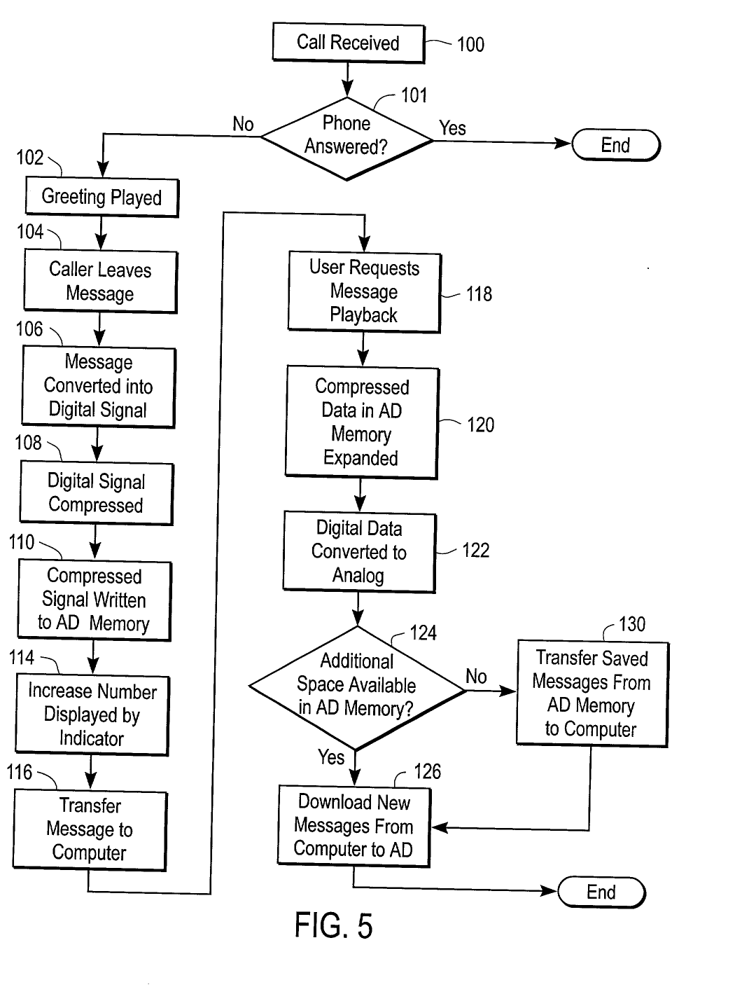

FIG. 5 is a flowchart illustrating a process of the present invention for transferring compressed data to the personal computer for storage thereon. At step 100 a call is received. If the telephone is not answered after a set number of rings, a message recorded within the answering machine is played (steps 101 and 102). Microprocessor 70 monitors any call unanswered by the connected telephone equipment and upon detection of a predetermined number of occurrences of the ringing signal, the microprocessor causes telephone circuitry to answer the call with the recorded greeting. In response to the greeting, the caller leaves a message (step 104). The audio signal of the incoming message is supplied to the codec through an audio signal line and converted into a digital signal in the codec 74 (step 106). The digital audio signal is then compressed by the DSP 72 (step 108) and written into memory 76 for at least temporary storage (step 110). Each time a message is recorded, the controller 78 increases the number of messages displayed by the indicator (step 114). Once the message is complete, as indicated by the caller hanging up or a prolonged silence, the answering device controller 78 transfers the compressed data to the personal computer 20 (step 116). The controller 78 may also be configured to transfer the data only when a certain percentage of the answering device's memory is full or partially full (e.g., 25% or 50% capacity remaining).

When the owner (user) of the answering system 10 returns home or calls in for his messages, the controller 78 first plays back any messages retained in the memory 76 of the answering device 12 (step 118). In order to play back the original audio message, the compressed data is expanded by the DSP 72 (step 120) and supplied to the codec 74 which converts the digital data back into the original analog incoming message audio signal (step 122). The user may delete unwanted messages after listening to each message. As space is freed in the answering device's memory 76, the compressed data stored on the personal computer 20 is downloaded by the controller 78 from the computer back to the answering device's memory (steps 124 and 126).

If the user does not erase any messages or does not erase a sufficient number of message to free up space for the messages stored in the computer 20, the answering system may notify the user that there are additional new messages stored on the computer 20. For example, the message indicator 19 may indicate that there are still new messages on the system. The user may then delete one or more of the messages stored on the answering device 12, or if he wants to save these messages, the controller 78 can transfer these messages to the personal computer 20 so that the new messages on the computer that have not yet been heard can be downloaded to the answering device and played to the user (step 130). The messages saved on the answering device 12 may be automatically transferred to the computer 20 or this may be initiated by the user of the system by selecting a function key on the answering device or pressing a number on the keypad of a telephone if the user is retrieving his messages remotely. It is to be understood that the process described above is only one example of a method for transferring data between the answering device 12 and computer 20. The controller 78 may be configured to transfer compressed data between the answering device 12 and computer 20 at different times or under other conditions.

An alternative method for recording messages on the computer 20 is to play back data on the telephone and record a WAV file on the personal computer. This, however, ties up the telephone line for the amount of time required to play and store the message on the computer. For example, if the message is five minutes in length, another call can not be received and recorded for at least five minutes.

Another option for playing back messages is to install the compression algorithm of the telephone answering device 12 on the personal computer 20 so that the computer can decompress and play back the messages in the same manner as the telephone. However, this requires installation of additional software on the personal computer 20.

As can be observed from the foregoing, the system and method of the present invention provide numerous advantages. For example, the present invention combines the reliability of a digital answering machine with the large storage capability of a personal computer. The method provides for fast transfer of messages between the answering device 12 and computer 20 and optimized storage of the messages.

Although the present invention has been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

What is claimed is:

1. A method for receiving and storing messages with a telephone answering system comprising a telephone answering device and a computer, the method comprising:
receiving an audio message from a caller at the answering device;
converting said audio message to a compressed digital message;
transferring said compressed digital message from the answering device to the computer for storage of said compressed digital message;
transferring said compressed digital message from the computer to the answering device when play back of said audio message is requested;
converting said compressed digital message to said audio message; and
playing said audio message from the answering device.

2. The method of claim 1 wherein converting said audio message to a compressed digital message comprises utilizing a DSP and codec.

3. The method of claim 1 wherein transferring said compressed digital message from the answering device to the computer comprises transferring the message when a percentage of memory of the answering device is full.

4. The method of claim 1 wherein transferring said compressed digital message from the computer to the answering device comprises transferring the message when sufficient space is available in memory of the answering device.

5. The method of claim 1 further comprising indicating the number of messages stored on the answering device and the computer on a message indicator of the answering device.

6. A telephone answering system operable to transfer messages to a personal computer having memory for storing the messages, the system comprising:
an answering device operable to receive an audio message from a caller, convert the audio message to a compressed digital message, and convert the compressed digital message back to said audio message when play back of the audio message is requested; and
a controller operable to transfer said compressed data to the personal computer for at least temporary storage thereon and transfer the compressed data back to the answering device for retrieval of said audio message.

7. The system of claim 6 wherein the answering device further comprises a DSP for compressing the audio message and expanding the compressed audio message.

8. The system of claim 6 wherein the answering device further comprises a codec for converting an analog audio message to a digital audio message and converting the digital audio message to the analog audio message.

9. The system of claim 6 further comprising a message indicator operable to indicate the number of stored messages on the answering device and the personal computer.

10. The system of claim 6 wherein the answering device is connected to a telephone network and a telephone.
